(19) United States
(12) Patent Application Publication
(10) Pub. No.: US 2007/0091179 A1
(43) Pub. Date: Apr. 26, 2007

(54) Digital camera module and assembling method with same

(75) Inventor: Shih-Chien Yen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/453,452

(22) Filed: Jun. 14, 2006

(30) Foreign Application Priority Data
Oct. 21, 2005 (CN) 200510100586.X

(51) Int. Cl. H04N 5/225

(52) U.S. Cl. 348/207.99

(57) ABSTRACT

A digital camera module (100) includes a barrel (10), a first lens element (14), a spacer (19) and a second lens element (18). The barrel defines a hole (102). The first lens element is received in the hole. The spacer is received in the hole and is pressed against the first lens element. The second lens element is received in the hole and is pressed against the spacer. A glue space (20) is formed between the first lens element and an inner periphery of the barrel for allowing the first lens element, the spacer and the second lens element to be fixed to the barrel.

### TECHNICAL FIELD

The present invention relates generally to camera modules, and more particularly, to a digital camera module for use in a portable electronic device, such as a mobile phone or a personal digital assistant (PDA), and also to a method of assembly.

### BACKGROUND

With the development of wireless communication technologies, increasing numbers of mobile phones and PDAs now include digital cameras as a special feature.

Generally, digital cameras are image recording media capable of photographing a plurality of still images without using film. Such a digital camera typically uses an image pickup device, which is a kind of semiconductor device, such as a charge coupled device (CCD) or complementary metal oxide semiconductor (CMOS). In the digital camera, an object image formed on the image pickup device through a lens is converted into an electronic signal by the image pickup device, and the electrical signal is stored as a digital signal, for example, either in the camera unit or in a mobile phone or PDA in which the digital camera is mounted. In such digital cameras, a high performance digital camera module mounted with an image sensor is in greatly increasing demand. In particular, a good image quality for digital camera is desired. The method used for assembling a digital camera module is one of factors which determine the image quality. The method needs not only to satisfy large-scale production, but also needs to maintain a clear and un-polluted image sensor area.

A typical digital camera module includes a barrel, a first lens element, a second lens element, a spacer, an aperture and a filter. The first lens element, the second lens element, the spacer, the aperture and the filter are received in the barrel. During assembly, firstly, the first lens element, the spacer, the second lens element and the aperture are placed in the barrel from a bottom-to-top in that order. Then, an ultraviolet glue (UV) is applied at the connection between the barrel and the aperture. After that, the filter is placed in the barrel, and pressed against the aperture. Finally, the UV glue is irradiated with UV light so as to solidify it and the filter is thus fixed in the barrel and the camera module elements are assembled together. However, with this method of assembly it is not easy to control the quantity of the glue used, and in addition, if the force pressing on the filter is not uniform, the glue might leak so as to effect the image quality.

Therefore, a digital camera module and an assembling method thereof is desired in order to overcome the above-described shortcomings.

### SUMMARY

In one aspect, a digital camera module includes a barrel, a first lens element, a spacer and a second lens element. The barrel defines a hole. The first lens element is received in the hole. The spacer is received in the hole and is pressed against the first lens element. The second lens element is received in the hole and is pressed against the spacer. A glue space is formed between the first lens element and the barrel for allowing the first lens element, the spacer and the second lens element to be fixed to the barrel.

In another aspect, a method of assembling a digital camera module includes the steps of: providing a barrel defining a hole; placing a first lens element, a spacer and a second lens element in the hole; forming a space between the first lens element and an inner periphery of the barrel; and applying an adhesive means in the space to fix the second lens element to the barrel.

Other advantages and novel features will become more apparent from the following detailed description when taken in conjunction with the accompanying drawings.

### BRIEF DESCRIPTION OF THE DRAWINGS

Many aspects of the digital camera module can be better understood with reference to the following drawings. The components in the drawings are not necessarily drawn to scale, the emphasis instead being placed upon clearly illustrating the principles of the digital camera module. Moreover, in the drawings, like reference numerals designate corresponding parts throughout the several views.

FIG. 1 is a cut-away view of an embodiment of a digital camera module;

FIG. 2 is an isometric view of one embodiment of a second lens element of the digital camera module;

FIG. 3 is an isometric view of another embodiment of a second lens element of a digital camera module; and

FIG. 4 is an isometric view of another embodiment of a second lens element of a digital camera module.

### DETAILED DESCRIPTION OF THE EMBODIMENTS

Referring now to the drawings, FIG. 1 shows a digital camera module 100, according to a preferred embodiment. The digital camera module 100 is adapted for use in a portable electronic device such as a mobile phone or a personal digital assistant (PDA), but its compact nature could also prove useful in compact digital camera units, digital camcorders or in regular film cameras. The digital camera module 100 includes a barrel 10, a filter 12, an aperture 13, a first lens element 14, a second lens element 18 and a spacer 19.

The barrel 10 is substantially cylindrical, and defines a stepped hole 102 in a central area. The stepped hole 102 communicates with two open ends of the barrel 10. The barrel 10 has an inner peripheral wall, and a step 104 is formed adjacent to one end of the barrel 10.

The filter 12 is made of optical glass. At least one surface of the filter 12 is coated with an IR-cut coating. The IR-cut coating can filter out incoming infrared rays so as to improve image quality.

The aperture 13 is used for controlling the amount of light entering into the digital camera module 100. The aperture 13 may be widened or narrowed so as to adjust the quantity of light.

The first lens element 14 and the second lens element 18 are substantially disk shaped. Such aspheric lens elements are relatively easy to make. Furthermore, the overall weight of the lens elements is light and, the lens elements are not easily damaged if they are subjected to shock, such as being dropped to the ground.

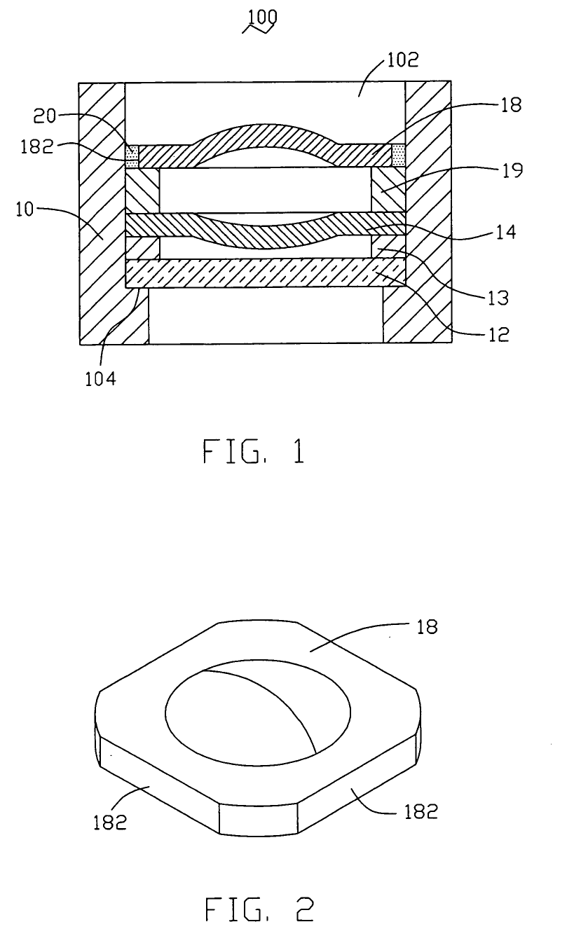

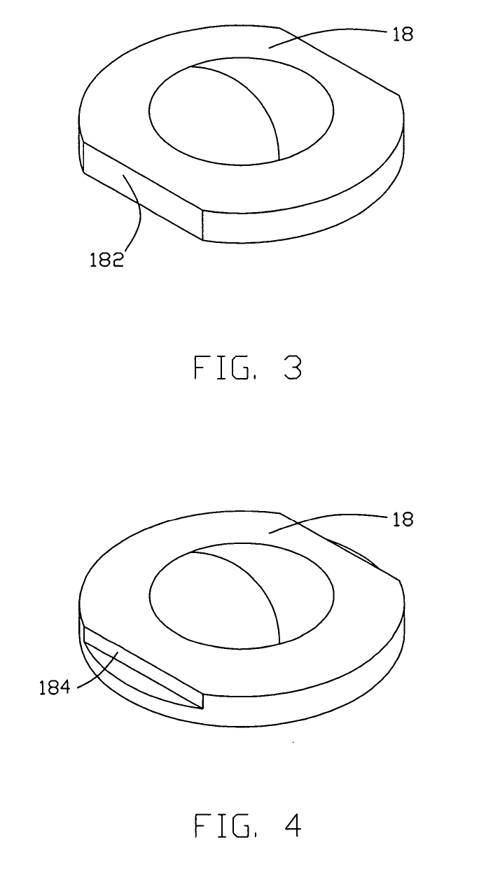

Referring to FIG. 2, one structure of the second lens element 18 symmetrically forms four plane surfaces 182 at a periphery. Referring to FIG. 3, another structure of the second lens element 18 symmetrically forms two opposite plane surfaces 182. Referring to FIG. 4, another structure of the second lens element 18 symmetrically forms two opposite plane surfaces 184. Each plane surface 182 only communicates with one side thereof. The above plane surfaces together with the peripheral wall of the barrel 10 may form a glue space 20 so as to allow the second lens element 18 to be fixed in the barrel 10.

The spacer 19 is made of metal and is used for adjusting the distance between the first lens element 14 and the second lens element 18 so as to avoid interference between lens elements.

A method of assembling the digital camera module includes the following steps where firstly placing the filter 12 in the stepped hole 102 of the barrel 10. Then filter 12 is pressed against the step 104 of the barrel 10. Secondly, the aperture 12, the first lens element 14, the spacer 19 and the second lens element 18 are placed in the stepped hole 102 of the barrel 10 in that order. The plane surfaces 182 or 184 and the peripheral wall of the barrel 10 cooperatively define a glue space 20. Finally, an ultraviolet glue (UV) is dropped into the glue space 20, and the ultraviolet glue is irradiated with UV light so as to solidify the ultraviolet glue. The second lens element 18 is thus fixed in the barrel and assembly is completed.

A main advantage of the digital camera module 100 is that the glue space 20 can reduce overflow, and, as the second lens element 18 has a non-circular shape, not only is the size of the glue space between the second lens element 18, the spacer and the barrel 10 increased, but also the bonding force between them is strengthened. Accordingly, the reliability of the digital camera module 100 is improved.

In alternative embodiments, the second lens element may be replaced with other structure such as an ellipse shape, rectangular or non-circular so as to provide the glue space.

In another alternative embodiment, the optical element arrangement of the first lens element, the filter, the aperture, the spacer and the second lens element may be changed, with only one optical element being provided with a glue space.

In other alternative embodiments, the stepped hole 102 may be omitted, and the optical elements located at two ends of the barrel can be fixed by adhesive means.

As described above, the preferred embodiment provides a digital camera module 100 for devices such as mobile phones, which has both simplicity and ease of use. It is, however, to be understood that the digital camera module 100 could potentially be useful in other applications in which it may be desirable to allow incoming light to be adjusted so as to attain a clear image.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

I claim:

1. A digital camera module, comprising:
a barrel defining a hole;
a first lens element being received in the hole;
a spacer being received in the hole and pressed against the first lens element; and
a second lens element being received in the hole and being pressed against the spacer;
wherein a glue space is formed between the first lens element and the barrel for allowing the first lens element, the spacer and the second lens element to be fixed to the barrel.

2. The digital camera module as claimed in claim 1, wherein the hole is a stepped hole defined by an inner peripheral wall of the barrel, the peripheral wall forms a step, and the first lens element presses against the step.

3. The digital camera module as claimed in claim 1, wherein the second lens element forms two plane surfaces, and the two plane surfaces and the barrel cooperatively form the glue space.

4. The digital camera module as claimed in claim 1, further comprising an aperture, the aperture is received in the hole of the barrel, and presses against the first lens element opposite to the spacer.

5. The digital camera module as claimed in claim 4, further comprising a filter, the filter is received in the hole of the barrel, and presses against the aperture.

6. The digital camera module as claimed in claim 5, wherein the hole is a stepped hole with a peripheral wall, the peripheral wall forms a step, and the filter presses against the step.

7. A digital camera module, comprising:
a barrel defining a hole with an inner peripheral wall; and
at least one optical element of a lens element and an aperture being received in the barrel;
wherein a glue space is configured between the optical element and the peripheral wall of the barrel for allowing the optical element to be fixed to the barrel.

8. The digital camera module as claimed in claim 7, wherein the at least one optical element includes a lens element received in the hole, and the lens element forms two plane surfaces, the plane surfaces and the peripheral wall of the barrel cooperatively form the glue space.

9. The digital camera module as claimed in claim 7, wherein the at least one optical element includes a first lens element, a spacer and a second lens element, the first lens element, the spacer and the second lens element are received in the hole, one of the first lens element, the spacer, and the second lens element situated at one end with the peripheral wall of the barrel forms the glue space.

10. The digital camera module as claimed in claim 9, wherein the second lens element forms two plane surfaces, the two plane surfaces and the barrel forms the glue space.

11. The digital camera module as claimed in claim 10, further comprising an aperture, the aperture is received in the hole of the barrel, and presses against the first lens element opposite to the spacer.

12. The digital camera module as claimed in claim 11, further comprising a filter, the filter is received in the hole of the barrel, and presses against the aperture.

13. A method of assembling a digital camera module, comprising the steps of:
providing a barrel, the barrel defining a hole;
placing a first lens element, a spacer and a second lens element in the hole with the spacer being located between the first and second lens elements;
forming a space between the first lens element and an inner periphery of the barrel; and
dropping an adhesive means into the space to fix the second lens element to the barrel.

14. The method as claimed in claim 13, wherein the adhesive means is an ultraviolet glue, and the ultraviolet glue can be irradiated with UV light so as to solidify the ultraviolet glue.

15. The method as claimed in claim 13, wherein the second lens element forms two plane surfaces, the two plane surfaces and the peripheral wall forms the glue space.

16. The method as claimed in claim 14, wherein the hole is a stepped hole with a peripheral wall, the peripheral wall forms a step, and the first lens element presses against the step.
